(19) United States
(12) Patent Application Publication
(10) Pub. No.: US 2007/0293628 A1
(43) Pub. Date: Dec. 20, 2007

(54) Article Comprising a Polyolefin Substrate and a Layer Coating at Least a Portion of the Surface of the Said Polyolefin Substrate, and Process and Use

(76) Inventors: Olivier Piernot, Brussels (BE); Luc Dewez, Ham-Sur-Sambre (BE); Lucienne Detournay, Brussels (BE); Henri Wautier, Braine Le Comte (BE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/577,412

(22) PCT Filed: Oct. 19, 2005
(86) PCT No.: PCT/EP05/55385

§ 371 Date: Apr. 18, 2007

(30) Foreign Application Priority Data
Oct. 20, 2004 (FR) 04/11171

(51) Int. Cl. C09D 151/06

(52) U.S. Cl. 525/71; 525/70

(57) ABSTRACT

Article comprising at least one substrate (S) comprising at least one polyolefin composition (C1) comprising at least one nonfunctionalized polyolefin (PO1), the said substrate comprising a surface, and at least one layer (Σ) coating at least a portion of the surface of the said substrate, the said layer (Σ) being composed of at least one polyolefin composition (C2) comprising at least one functionalized polyolefin (POg) obtained by grafting acid and/or anhydride groups to at least one nonfunctionalized polyolefin (PO2), the acid and/or anhydride groups optionally being neutralized in all or in part by at least one neutralizing agent, and at least one emulsifying agent. Process for the manufacture of such an article. Improvement in the antistatic properties of the substrate (S) by means of the layer (Σ).

The present invention relates to an article comprising a polyolefin substrate and a layer coating at least a portion of the surface of the said substrate, to a process for the manufacture of such an article and to a specific use of the layer coating the said substrate.

As long as they have existed, nonfunctionalized polyethylenes and polypropylenes and more generally nonfunctionalized polyolefins have been valued for their advantageous properties in conjunction with their low cost. Thus, at the present day, they are used, preferably with any other plastic, in numerous applications, in particular essentially one-dimensional articles, such as fibres, essentially two-dimensional articles, such as films, sheets and hollow bodies with thin walls, and various essentially three-dimensional articles, such as hollow bodies with thick walls and solid bodies.

However, it often happened that the level of the properties, in particular of the surface properties and more particularly still of the antistatic properties, achieved by articles made of nonfunctionalized polyethylene or polypropylene and more generally by articles made of nonfunctionalized polyolefin did not achieve the level required for the applications envisaged.

It is known that nonfunctionalized polyolefins are excellent electrical insulators. The counterpart of this advantage is the accumulation of static electricity, the discharge of which takes place only very slowly. The risks of such an accumulation of charges are mainly significant contamination of the surfaces of polyolefin articles (dust, and the like), the creation of sparks, which can cause an explosion in an explosive environment, and the slowing down of the process for the manufacture of the said articles.

It has already been reported that a substantial improvement in the level of the antistatic properties of nonfunctionalized polypropylenes can sometimes be obtained by reducing their molecular mass and by grafting anhydride groups thereto. Thus, Patent Application JP 53/137292, on behalf of Mitsui Toatsu Chem., discloses a process according to which an isotactic polypropylene is partially depolymerized (decomposed) in an extruder using a peroxide and under the action of heat and then the polypropylene thus obtained is reacted under hot conditions in an organic solvent in the presence of a peroxide and of maleic anhydride; a polypropylene grafted with maleic anhydride possessing improved antistatic properties is finally obtained. Such a process is very difficult to carry out (in particular because it requires the presence of organic solvent). It results in the production of very expensive grafted polypropylenes which are far more expensive than nonfunctionalized polypropylenes and, what is more, exhibit antistatic properties generally at a still relatively mediocre level.

It is also well known that certain specific additives, known under the name of antistatic agents, can be used to improve the antistatic properties of articles based on nonfunctionalized polyolefins. The antistatic agents of nonfunctionalized polyolefins are compounds which usually exhibit a hydrophilic part and a hydrophobic part. Some of them can certainly also be used as emulsifying agents, such as quaternary ammonium salts (antistatic agents and cationic emulsifiers) and alkaline alkylsulphonates (antistatic agents and anionic emulsifiers). However, at the very least as regards polyolefins, the most widely used antistatic agents by far, as reported in particular in “Plastics Additives—An A-Z Reference”, 1st ed. (1998), pp. 111-112, and in “Plastics Additives Handbook”, 4th ed. (1993), pp. 752-754, are not usually emulsifying agents. Thus, mention may be made, as ordinary antistatic agents for polyolefins, of polyethylene glycol esters and ethers, fatty acid esters and ethanolamides, fatty acid glycerides, fatty amine mono- and diglycerides, and condensates of ethylene oxide with fatty amine; although undeniably having some surfactant properties, these antistatic agents of nonionic type are not, with the exception perhaps (and marginally) of the last mentioned condensates of ethylene oxide with fatty amine, effective emulsifying agents recognized as such, in contrast to condensates of alkylene oxide with fatty acid, with aliphatic fatty alcohol or with alkylphenol.

Various methods for using antistatic agents are described in the prior art. Thus, the “Plastics Additives Handbook” describes the direct incorporation in the plastic of the antistatic agent (“internal antistatic agent”); it additionally specifies that, because of their low polarity, nonionic antistatic agents are ideal internal antistatic agents for polyethylene and polypropylene. Although they are supposed to be ideal, the Applicant has observed that the usual internal antistatic agents for articles made of polyethylene or of polypropylene can suffer from a lack of effectiveness attributed in particular to their difficulty in migrating towards the surface of these articles.

Another method of incorporation described in the same “Plastics Additives Handbook” consists in applying a solution of an antistatic agent (then referred to as “external antistatic agent”) at the surface of a polyolefin article, for example by spraying, moistening or immersing the article in the said solution and by then drying the surface; for such an “external” application, the nature of the antistatic agent would be less critical and numerous nonsurfactant substances, a fortiori nonemulsifying substances, such as glycerol, polyols and polyglycols, would be used, even extensively, as external antistatic agents. According to the “Plastics Additives Handbook”, the “external” method of application would exhibit two main disadvantages: it would necessitate high equipment and operating costs and would suffer from the low resistance of the external antistatic agent to be retained at the surface of the polyolefin article.

The Applicant has found that, entirely surprisingly, the fact of applying a coating comprising the noteworthy combination of a functionalized polyolefin of a specific type and of an effective emulsifying agent which is recognized as such to a polyolefin substrate advantageously made it possible to solve all the abovementioned problems and many others still.

First of all, a subject-matter of the present invention is consequently an article comprising a polyolefin substrate which exhibits numerous advantages, in particular improved surface properties and still more particularly improved antistatic properties, with respect to the articles of the same type of the prior art without exhibiting the disadvantages thereof.

To this end, the invention relates to an article comprising at least one substrate (S) comprising at least one polyolefin composition (C1) comprising at least one nonfunctionalized polyolefin (PO1), the said substrate comprising a surface,

and at least one layer (Y) coating at least a portion of the surface of the said substrate, the said layer (Y) being composed of at least one polyolefin composition (C2) comprising:
at least one functionalized polyolefin (POg) obtained by grafting acid and/or anhydride groups to at least one nonfunctionalized polyolefin (PO2), the acid and/or anhydride groups optionally being neutralized in all or in part by at least one neutralizing agent, and
at least one emulsifying agent.

The weight of the substrate (S) and of the layer (Σ) together advantageously represent more than 10%, preferably more than 50% and particularly preferably more than 90% of the weight of the article according to the invention. In a very particularly preferred way, the article according to the invention is composed essentially of the substrate (S) and of the layer (Σ). In the most preferred way, the article according to the invention is composed of the substrate (S) and of the layer (Σ).

The substrate (S) can be in particular an essentially three-dimensional body, an essentially two-dimensional body or an essentially one-dimensional body.

From a practical viewpoint, any body is three-dimensional and can consequently be characterized by three characteristic dimensions (“length”, “width” and “height”). However, some bodies are such that one or more of their characteristic dimensions is (are) considerably less than the other two or than the third respectively. Specifically, for the purposes of the present invention:
an essentially three-dimensional body is a body, none of the characteristic dimensions of which is considerably less than the others;
an essentially two-dimensional body is a body, one of the characteristic dimensions (“thickness-height”) of which is considerably less than the other two (“length” and “width”), and
an essentially one-dimensional body is a body, two of the characteristic dimensions (“thickness-width” and “thickness-height”) of which are considerably less than the third (“length”).

From a mathematical viewpoint, the essentially three-dimensional bodies have the appearance of a geometric volume, the essentially two-dimensional bodies have essentially the appearance of a geometric surface and the essentially one-dimensional bodies have essentially the appearance of a geometric line. An essentially two-dimensional body can also be seen as a surface (with a certain length and a certain width), which differs from a geometric surface in that it has a nonzero thickness (typically in a direction perpendicular to the surface), the said nonzero thickness being, however, considerably less than the square root of the area deployed by the surface itself and more specifically the said nonzero thickness being considerably less both than the length and than the width of the surface itself. With regard to an essentially one-dimensional body, it can also be seen as a line (of a certain length), which differs from a geometric line in that it has a nonzero thickness-area (typically in a plane perpendicular to the line, with a certain nonzero thickness-width and a certain nonzero thickness-height as characteristic dimensions), the said nonzero thickness-area being, however, considerably less than the square of the length of the line and, more specifically, the said nonzero thickness-width and the said nonzero thickness-height being considerably less than the length of the line. The geometric surface can be flat or curved, twisted or nontwisted; the geometric line can be a straight line or a curved line.

The thickness of a body is advantageously defined as
t=∫_{V}Σ(x,y,z)dx dy dz/V,
where x, y and z are the coordinates of a volume element dV (dV=dx.dy.dz) of the body of volume V and τ is the local thickness.

The local thickness c associated with a material point of coordinates (x,y,z) is defined as being the shortest length of the straight line segment D which passes through the material point in question and which crosses right through the body (that is to say, which goes from a material point where D enters the body as far as a material point where D exits from the body).

A first preferred substrate (S) is an essentially two-dimensional body [substrate (S1)].

The thickness t of the substrate (S1) preferably obeys the relationship:
t<(V/k²)^{1/3} [which is equivalent to V>(k·t)·(k·t)·t] (rel-1)
where V is the volume of the substrate (S1), k is equal to 10, t is expressed in mm and V is expressed in mm³.

The thickness t of the substrate (S1) particularly preferably obeys the relationship (rel-1) above in which k has been changed and henceforth has the value 100.

In addition, the thickness t of the substrate (S1) preferably obeys the relationship:
t<(S/2)^{1/2} [which is equivalent to S>2·(k_{b}·t)·(k_{b}·t)] (rel-2)
where S is the area deployed by the surface of the substrate (S1), k_{b}=10, t is expressed in mm and S is expressed in mm².

The thickness t of the substrate (S1) particularly preferably obeys the relationship (rel-2) above in which k_{b} has been changed and henceforth has the value 100.

A first preferred substrate (S1) is a substrate having a thickness t of less than 500 μm [substrate (S1-1)]. Such a substrate (S1) is commonly referred to as a “film”.

The substrate (S1-1) has a thickness preferably of less than 250 μm.

The substrate (S1-1) has a thickness preferably of greater than 5 μm.

The substrate (S1-1) preferably obeys the relationship (rel-1) in which k has been changed and henceforth has the value 1000. The substrate (S1-1) particularly preferably obeys the relationship (rel-1) in which k has been changed and henceforth has the value 10 000.

The substrate (S1-1) is preferably flexible. It is particularly preferred for the substrate (S1-1) to be able to be bent so that it acquires or recovers the form of a rectangular parallelepiped, the thickness of which is considerably less than its length and than its width; the substrate (S1-1) then resembles a “plane of extremely low thickness”.

A second preferred substrate (S1) is a substrate having a thickness t of 500 μm to 5000 μm [substrate (S1-2)].

The substrate (S1-2) is preferably a rectangular parallelepiped, the thickness of which is considerably less than its length and than its width; the substrate (S1-2) then resembles a “plane of very low thickness”. Such a substrate is commonly referred to as a “thin sheet”.

A third preferred substrate (S1) is a substrate having a thickness t of greater than 5000 μm [substrate (S11-3)].

The substrate (S1-3) is preferably a rectangular parallelepiped, the thickness of which is considerably less than its length and than its width; the substrate (S1-3) then resembles a “plane of low thickness”. Such a substrate is commonly referred to as a “thick sheet”.

The substrate (S1-3) is advantageously rigid.

A fourth preferred substrate (S1) is a hollow body with thin walls, that is to say the thickness t of which is less than 5 mm [substrate (S11-4)].

The thickness of the walls of the substrate (S1-4) advantageously has the value of the thickness t of substrate (S1-4).

The substrate (S1-4) has a thickness t preferably of greater than 500 μm. It additionally has a thickness t preferably of less than 2500 μm.

A second preferred substrate (S) is an essentially one-dimensional body [substrate (S2)].

The thickness t of the substrate (S2) is preferably less than 10 mm, particularly preferably less than 250 μm and very particularly preferably less than 50 μm.

The thickness t of the substrate (S2) preferably obeys the relationship:
t<(V/k′)^{1/3} [which is equivalent to V>(k′·t)·t·t] (rel-3)

where V is the volume of the substrate (S2), k′ is equal to 10, t is expressed in mm and V is expressed in mm³.

The thickness t of the substrate (S2) particularly preferably obeys the relationship (rel-3) above in which k′ has been changed and henceforth has the value 100. It very particularly preferably obeys the relationship (rel-3) above in which k′ has been changed and henceforth has the value 1000. It most preferably obeys the relationship (rel-3) above in which k′ has been changed and henceforth has the value 10 000.

In addition, the thickness t of the substrate (S2) preferably obeys the relationship:
t<(S/k′_{b})^{1/2} [which is equivalent to S>4·(k′_{b}·t)·t] (rel-4)

where S is the area deployed by the surface of the substrate (S2), k′_{b}=10, t is expressed in mm and S is expressed in mm².

The thickness t of the substrate (S2) particularly preferably obeys the relationship (rel-4) above in which k′_{b} has been changed and henceforth has the value 100. It very particularly preferably obeys the relationship (rel-4) above in which k′_{b} has been changed and henceforth has the value 1000. It most preferably obeys the relationship (rel-4) above in which k′_{b} has been changed and henceforth has the value 10 000.

It is preferable for the substrate (S2) to have the appearance of a solid cylinder, the diameter of which is considerably less than its length; the substrate (S2) then resembles a straight line having an extremely small diameter. Such a substrate is commonly referred to as a “fibre”.

The thickness t of the substrate (S2) is preferably greater than 5 μm. The substrate (S2) additionally has a thickness t preferably of less than 5000 μm, particularly preferably of less than 500 μm and very particularly preferably of less than 50 μm.

A third preferred substrate (S) is an essentially three-dimensional body [substrate (S3)].

A first preferred substrate (S3) is a hollow body with thick walls, that is to say the thickness t of which is greater than 5 mm [substrate (S3)].

The thickness of the walls of the substrate (S3) advantageously has the value of the thickness t of substrate (S3).

The substrate (S3) has a thickness t usually of greater than 10 mm. In addition, it has a thickness t preferably of less than 100 mm.

The weight of the polyolefin composition (C1) with respect to the weight of the substrate (S) advantageously has a value of more than 50%, preferably of more than 90%. Particularly preferably, the substrate (S) is composed essentially of the polyolefin composition (C1). Very particularly preferably, the substrate (S) is composed of the polyolefin composition (C1).

The term “polyolefin” is intended to denote a polymer, more than 50% by weight of the repeat units of which are derived from at least one olefin.

The term “olefin” is intended here to denote a monoolefin. The olefin can in particular be branched or linear. Mention may be made, as examples of linear olefins, of ethylene, propylene, 1-butene, 1-pentene, 1-hexene, 1-heptene, 1-octene, 1-nonene and 1-decene.

A nonfunctionalized polyolefin within the meaning of the present invention is a polyolefin devoid of a functional group, whatever the nature, whatever the form (a.o. the functional group can be copolymerized or grafted); a nonfunctionalized polyolefin within the meaning of the present invention is in particular devoid of repeat units derived from an ethylenically unsaturated comonomer exhibiting at least one functional group, such as ethylenically unsaturated carboxylic acids, their metal salts and their esters, or vinyl esters; it is also in particular devoid of functional groups grafted using grafting agents such as ethylenically unsaturated carboxylic acids, their anhydrides, their metal salts and their esters.

Preferably, at least 80% by weight, particularly preferably at least 90% by weight and very particularly preferably all the repeat units of the non-functionalized polyolefin (PO1) are derived from at least one olefin.

Advantageously, more than 50% by weight of the repeat units of the nonfunctionalized polyolefin (PO1) are derived from one and the same olefin (O1).

The olefin (O1) is preferably linear.

The olefin (O1) preferably comprises from 2 to 8 carbon atoms, particularly preferably from 2 to 6 carbon atoms.

A first olefin (O1) which is very particularly preferred is ethylene. For the purposes of the present invention, a polyolefin for which more than 50% by weight of the repeat units are derived from ethylene is a polyethylene; good results have been obtained when the nonfunctionalized polyolefin (PO1) was a polyethylene.

A second olefin (O1) which is very particularly preferred is propylene. For the purposes of the present invention, a polyolefin for which more than 50% by weight of the repeat units are derived from propylene is a polypropylene; good results have been obtained when the nonfunctionalized polyolefin (PO1) was a polypropylene.

The nonfunctionalized polyolefin (PO1) can in particular be a homopolymer or a copolymer.

The optional comonomers of the olefin (O1) are advantageously chosen from the linear olefins described above, from styrene (optionally substituted by one or more hydrocarbyl groups) or from diolefins comprising from 4 to 18 carbon atoms, such as 4-vinylcyclohexane, dicyclopentadiene, methylene- and ethylidenenorbornene, 1,3-butadiene, isoprene and 1,3-pentadiene. They are preferably chosen from the above linear olefins.

Preferably, at least 60% by weight and particularly preferably at least 65% by weight of the repeat units of the nonfunctionalized polyolefin (PO1) are derived from the olefin (O1).

Excellent results have in particular been obtained when the nonfunctionalized polyolefin (PO1) was a blend composed, on the one hand, of a propylene homopolymer or of a random copolymer of propylene and of ethylene comprising from 2 to 6% by weight of repeat units derived from ethylene and, on the other hand, of a diblock copolymer, one block of which is a block of a propylene homopolymer or of a random copolymer of propylene and of ethylene comprising from 2 to 6% by weight of repeat units derived from ethylene and the other block of which is a block of a copolymer of propylene and of ethylene comprising from 20 to 45% by weight of repeat units derived from ethylene.

The polyolefin composition (C1) advantageously comprises more than 50% by weight, preferably more than 90% by weight, particularly preferably more than 95% by weight and very particularly preferably more than 99% by weight, with respect to the total weight of the composition, of the nonfunctionalized polyolefin (PO1).

The polyolefin composition (C1) can optionally additionally comprise in particular conventional additives for polyolefin compositions in an amount advantageously ranging up to 40% by weight, preferably up to 10% by weight, particularly preferably up to 5% by weight and very particularly preferably up to 1% by weight, with respect to the total weight of the composition.

Mention may be made, as examples of such conventional additives, of antioxidants, such as sterically hindered phenols, lubricants, fillers, colorants, nucleating agents, UV stabilizers, antiacids, such as calcium stearate, and metal-deactivating agents.

The polyolefin composition (C1) is advantageously devoid of antistatic agent.

The polyolefin composition (C1) is advantageously devoid of emulsifying agent.

The polyolefin composition (C1) is advantageously devoid of grafted polyolefin, preferably devoid of functionalized polyolefin and particularly preferably devoid of any polymer other than the nonfunctionalized polyolefin (PO1).

The layer (Σ) advantageously has a thickness of between 0.1 and 1000 μm.

The layer (Σ) has a thickness preferably of greater than 1 μm, particularly preferably of greater than 5 μm, and very particularly preferably of greater than or equal to 8 μm.

In addition, the layer (Σ) has a thickness preferably of less than 100 μm, particularly preferably of less than 50 μm, very particularly preferably of less than or equal to 30 μm.

Excellent results have been obtained when the layer (Σ) had a thickness of between 8 and 30 μm.

Preferably, at least 80% by weight, particularly preferably at least 90% by weight and very particularly preferably all the repeat units of the non-functionalized polyolefin (PO2) are derived from at least one olefin.

Advantageously, more than 50% by weight of the repeat units of the nonfunctionalized polyolefin (PO2) are derived from one and the same olefin (O2).

The olefin (O2) is preferably linear.

The olefin (O2) preferably comprises from 2 to 8 carbon atoms, particularly preferably from 2 to 6 carbon atoms.

A first olefin (O2) which is very particularly preferred is ethylene. Good results have been obtained when the nonfunctionalized polyolefin (PO2) was a polyethylene, in particular when the nonfunctionalized polyolefin (PO1) was a polyethylene and also when the nonfunctionalized polyolefin (PO1) was a polypropylene. A second olefin (O2) which is very particularly preferred is propylene. Good results have been obtained when the nonfunctionalized polyolefin (PO2) was a polypropylene, in particular when the nonfunctionalized polyolefin (PO1) was a polypropylene and also when the nonfunctionalized polyolefin (PO1) was a polyethylene.

The nonfunctionalized polyolefin (PO2) can in particular be a homopolymer or a copolymer.

The optional comonomers of the olefin (O2) are advantageously chosen from the same list of monomers as that composed of the optional comonomers of the olefin (O1).

Preferably, at least 80% by weight, particularly preferably at least 90% by weight and very particularly preferably at least 94% by weight of the repeat units of the nonfunctionalized polyolefin (PO2) are derived from the olefin (O2).

Excellent results have been obtained when the nonfunctionalized polyolefin (PO2) was a propylene homopolymer or a random copolymer of propylene and of ethylene comprising from 2 to 6% by weight of repeat units derived from ethylene, in particular when the nonfunctionalized polyolefin (PO1) was a blend composed, on the one hand, of a propylene homopolymer or of a random copolymer of propylene and of ethylene comprising from 2 to 6% by weight of repeat units derived from ethylene and, on the other hand, of a diblock copolymer, one block of which is a block of a propylene homopolymer or of a random copolymer of propylene and of ethylene comprising from 2 to 6% by weight of repeat units derived from ethylene and the other block of which is a block of a copolymer of propylene and of ethylene comprising from 20 to 45% by weight of repeat units derived from ethylene.

The acid and/or anhydride groups are advantageously grafted to the nonfunctionalized polyolefin (PO2) with the involvement of at least one graftable monomer, optionally in the presence of at least one radical-generating agent.

The acid and/or anhydride groups are preferably grafted to the nonfunctionalized polyolefin (PO2) with the involvement of at least one graftable monomer and of at least one radical-generating agent.

The graftable monomer can be a monoethylenically unsaturated mono- or dicarboxylic acid or an anhydride or a metal salt derived from the mono- or dicarboxylic acid. The graftable monomer preferably comprises from 3 to 20 carbon atoms. The graftable monomer is particularly preferably chosen from acrylic acid, methacrylic acid, maleic acid, fumaric acid, itaconic acid, crotonic acid, citraconic acid, maleic anhydride, itaconic anhydride, crotonic anhydride and citraconic anhydride. Maleic anhydride is very particularly preferred as graftable monomer.

Mention may be made, as examples of radical-generating agents, of in particular t-butyl cumyl peroxide, 1,3-di(2-(t-butylperoxy)isopropyl)benzene, 2,5-dimethyl-2,5-di(t-butylperoxy)hexane, di(t-butyl)peroxide and 2,5-dimethyl-2,5-di(t-butylperoxy)-3-hexyne. 2,5-Dimethyl-2,5-di(t-butylperoxy)hexane (DHBP) has made it possible to synthesize functionalized polyolefins which have given good results relating to the various aspects of the present invention.

Use may be made, for carrying out the grafting, of any device known for this purpose. Thus, it is possible to operate without distinction with mixers of external or internal type. Mixers of internal type are the most appropriate and, among these, batchwise Brabender® mixers and continuous mixers, such as extruders. The extruders usually comprise at least the following parts: a feed zone and, at its outlet, a discharge zone preceded by a compression zone, the latter forcing the molten mass to pass through the discharge zone. The grafting is preferably carried out in an extruder.

The amount of grafted acid and/or anhydride groups, expressed as amount of graftable monomer grafted with respect to the weight of the functionalized polyolefin (POg), is advantageously greater than 0.10% by weight, preferably greater than 0.20% by weight, particularly preferably greater than 0.30% by weight. In addition, this amount is advantageously less than or equal to 2.0% by weight, preferably less than or equal to 1.5% by weight and particularly preferably less than or equal to 1.0% by weight.

As indicated above, at least a portion of the acid and/or anhydride groups included in the functionalized polyolefin (POg) can optionally be neutralized, in all or in part, by at least one neutralizing agent.

A preferred functionalized polyolefin (POg) is a functionalized polyolefin, the acid and/or anhydride groups of which are not neutralized.

Another preferred functionalized polyolefin (POg) is a functionalized polyolefin, the acid and/or anhydride groups of which are neutralized, in all or in part, by at least one neutralizing agent.

The neutralizing agent can comprise in particular at least one inorganic salt or at least one organic salt or also a mixture of at least one organic salt and of at least one inorganic salt.

The inorganic salt, whether used alone or as a mixture, is preferably a carbonate, a bicarbonate, a phosphate or a monohydrogenphosphate of a metal which can in particular be an alkali metal, an alkaline earth metal, a metal from Group IIIa of the Periodic Table of the Elements or a transition metal. Carbonates are particularly preferred. Sodium carbonate is very particularly preferred.

The organic salt, whether used alone or as a mixture, is preferably a carboxylate or a mono- or polyhydroxycarboxylates of a metal which can be in particular an alkali metal, an alkaline earth metal, a metal from Group IIIa of the Periodic Table of the Elements or a transition metal.

The neutralizing agent preferably comprises at least one organic salt, such as zinc acetate, sodium lactate and sodium tartrate.

The neutralizing agent particularly preferably comprises at least one organic salt and at least one inorganic salt, such as the pairs zinc acetate and sodium carbonate and sodium lactate and sodium carbonate.

The neutralizing agent is preferably free of hydroxide of a metal.

The neutralizing agent is used in an amount preferably of greater than 0.5 molar equivalent with respect to the number of acid and/or anhydride groups of the functionalized polyolefin (POg). In addition, it is used in an amount preferably of less than 3 molar equivalents with respect to the number of acid and/or anhydride groups of the functionalized polyolefin (POg).

The functionalized polyolefin (POg) has a weight-average molecular mass advantageously of less than 80 000, preferably of less than 70000 and particularly preferably of less than 60 000. In addition, the functionalized polyolefin (POg) has a weight-average molecular mass advantageously of greater than 10 000, preferably of greater than 20 000 and particularly preferably of greater than 30 000. Excellent results have been obtained when the polyolefin (POg) had a weight-average molecular mass of between 30 000 and 60 000.

The weight-average molecular mass of the functionalized polyolefin (POg) is advantageously determined by gel permeation chromatography (GPC) with 1,2,4-trichlorobenzene as solvent.

The functionalized polyolefin (POg) advantageously comprises little in the way of free (nongrafted) graftable monomer. This amount is preferably less than 500 ppm. It is particularly preferably less than 200 ppm.

The polyolefin composition (C2) advantageously comprises more than 25% by weight, preferably more than 50% by weight, particularly preferably more than 60% by weight and very particularly preferably more than 70% by weight, with respect to the total weight of the composition, of the functionalized polyolefin (POg).

The polyolefin composition (C2) is advantageously devoid of functionalized polyolefin other than the functionalized polyolefin (POg) and is preferably devoid of any polymer other than the functionalized polyolefin (POg).

Mention may be made, as examples of emulsifying agents, of anionic emulsifying agents, alkoxylated anionic emulsifying agents, cationic emulsifying agents, alkoxylated cationic emulsifying agents, amphoteric emulsifying agents, alkoxylated amphoteric emulsifying agents and alkoxylated nonionic emulsifying agents.

For the purposes of the present invention, the terms “anionic emulsifying agents”, “cationic emulsifying agents” and “amphoteric emulsifying agents” denote nonalkoxylated emulsifying agents, in contrast to the various alkoxylated emulsifying agents listed above.

Mention may be made, as examples of cationic emulsifying agents, of primary amine hydrochlorides, secondary amine hydrochlorides and quaternary ammonium salts, such as the emulsifying agent Noramium® CES80 sold by Ceca.

Mention may be made, as examples of anionic emulsifying agents, of sodium mono- or dialkylsulphosuccinates; sodium or ammonium nonylphenyl phosphates; sodium, ammonium or potassium alkylcarboxylates; sodium or ammonium alkyl sulphates, such as ammonium or sodium, linear or branched, C₆, C₈, C₁₀, C₁₂, C₁₄, C₁₆ or C₁₈ alkyl sulphates; sodium primary or secondary alkyl-sulphonates; and sodium or ammonium alkylaryl-sulphonates, such as sodium or ammonium n-dodecylbenzenesulphonate or tetrapropylbenzenesulphonate.

Mention may be made, as amphoteric emulsifying agents, of emulsifying agents which comprise a carboxyl group (—COOH at acidic pH/—COO^{-Na}⁺, for example, at basic pH) and an amine group (—NH₂ at basic pH and —NH₃⁺Cl⁻ at acidic pH).

As indicated herebefore, the emulsifying agent may be alkoxylated. An alkoxylated emulsifying agent is an emulsifying agent, the chemical structure of which comprises a —(—R′—O—)ⱼ block where R′ is an alkylene group and where j is an integer which is strictly positive. Mention may be made, as examples of appropriate alkylene groups, of the ethylene group (in this case, the emulsifying agent is said to be ethoxylated), the propylene group (propoxylated emulsifying agent) and the alkylene groups comprising more than 3 carbon atoms. The ethoxylated emulsifying agents and the propoxylated emulsifying agents are preferred among the alkoxylated emulsifying agents. Besides, among the alkoxylated emulsifying agents, these having a degree of alkoxylation j of less than 30 are preferred; the alkoxylated emulsifying agents having a degree of alkoxylation j of 2 to 15 are particularly preferred; the alkoxylated emulsifying agents having a degree of alkoxylation j of 4 to 12 (i.e. comprising at least 4 and at most 12 mol of alkylene oxide) are very particularly preferred.

Mention may be made, as examples of alkoxylated cationic emulsifying agents, of ethoxylated primary amine hydrochlorides and ethoxylated secondary amine hydrochlorides, such as the hydrochlorides of certain emulsifying agents of the Noramox® range which are sold by Ceca.

Mention may be made, as examples of alkoxylated anionic emulsifying agents, of ethoxylated sodium monoalkyl sulphosuccinates; alkoxylated sodium or ammonium nonylphenyl phosphates; ethoxylated ammonium or sodium alkyl sulphates, such as ethoxylated sodium n-lauryl sulphates comprising 2, 4, 6, 8, and 12 mol of ethylene oxide (that is to say, for which j has the value 2, 4, 6, 8, 10 or 12 respectively); or alkoxylated alkylarylsulphonates, such as alkoxylated octyl- and nonylphenylsulphonates.

Mention may be made, as alkoxylated amphoteric emulsifying agents, of emulsifying agents which comprise a carboxyl group (—COOH at acidic pH/—COO⁻Na⁺, for example, at basic pH) and an amine group (—NH₂ at basic pH and —NH₃⁺Cl⁻ at acidic pH) which are ethoxylated with 4 or 8 mol of ethylene oxide.

Mention may be made, as examples of alkoxylated nonionic agents, of condensates of alkylene oxide with fatty acid, such as condensates of ethylene oxide with lauric acid comprising 5 or comprising 10 mol of ethylene oxide; condensates of alkylene oxide with fatty alcohol, such as condensates of ethylene oxide with lauryl alcohol comprising 2, 4, 7, 10 or 12 mol of ethylene oxide and condensates of propylene oxide with lauryl alcohol comprising 4 or 8 mol of propylene oxide; condensates of alkylene oxide with alkylphenol, such as condensates of ethylene oxide with nonylphenol or condensates of ethylene oxide with octylphenol, and such as condensates of propylene oxide with nonylphenol; ethoxylated sorbitan esters, condensates of ethylene oxide with fatty amide and condensates of ethylene oxide with fatty amine.

The alkoxylated nonionic agents are often condensates of alkylene oxide with a fatty substance (acid, alcohol, amide, amine). If appropriate, the said fatty substance advantageously comprises from 6 to 24 carbon atoms, preferably from 10 to 18 carbon atoms and particularly preferably from 12 to 16 carbon atoms.

A first preferred emulsifying agent, which confers certain specific advantages on the article, is chosen from cationic emulsifying agents [emulsifying agent (E1)].

The emulsifying agent (E1) is preferably a quaternary ammonium salt.

A second preferred emulsifying agent, which confers other certain specific advantages on the article, is alkoxylated; it is chosen from alkoxylated anionic emulsifying agents, alkoxylated cationic emulsifying agents, alkoxylated amphoteric emulsifying agents or alkoxylated nonionic emulsifying agents [emulsifying agent (E2)].

The emulsifying agent (E2) is preferably:
either an alkoxylated cationic emulsifying agent,
or an alkoxylated nonionic emulsifying agent chosen from condensates of alkylene oxide with fatty acid, condensates of alkylene oxide with fatty alcohol and condensates of alkylene oxide with alkylphenol.

The polyolefin composition (C2) advantageously comprises more than 0.5% by weight, preferably more than 5% by weight, particularly preferably more than 10% by weight and very particularly preferably more than 15% by weight, with respect to the total weight of the composition, of the emulsifying agent. In addition, it advantageously comprises less than 50% by weight, preferably less than 40% by weight and particularly preferably less than 30% by weight, with respect to the total weight of the composition, of the emulsifying agent.

The polyolefin composition (C2) can optionally additionally comprise in particular conventional additives for polyolefin compositions in an amount advantageously ranging up to 40% by weight, preferably up to 10% by weight, particularly preferably up to 5% by weight and very particularly preferably up to 1% by weight, with respect to the total weight of the composition. Examples of conventional additives for polyolefin compositions have been described above.

The polyolefin composition (C2) is advantageously devoid of nonemulsifying antistatic agent. Within the meaning of the present invention, polyethylene glycol esters and ethers, fatty acid esters and ethanolamides, fatty acid glycerides and fatty amine mono- and diglycerides are nonemulsifying antistatic agents.

The polyolefin composition (C2) is generally devoid of additives not conventional for polyolefin compositions. However, according to a specific embodiment of the invention, the polyolefin composition (C2) advantageously additionally comprises elemental carbon, preferably carbon powder or carbon nanotubes and particularly preferably carbon nanotubes. The elemental carbon is advantageously dispersed finely and homogeneously in the polyolefin composition (C2). According to this specific embodiment, the amount of elemental carbon advantageously has a value from 0.1 to 10% by weight and preferably from 1 to 5% by weight, with respect to the total weight of the composition. The article manufactured according to the specific embodiment of the invention in question advantageously exhibits an improved surface electrical conductivity, preferably an improved surface electrical conductivity and an improved surface thermal conductivity.

The article according to the invention can be in particular an intermediate in the manufacture of a semifinished or finished product, a semifinished product or a finished product. According to a specific embodiment of the present invention, the article according to the invention is a finished product. The article according to the invention advantageously exhibits properties of a high level, significantly improved with respect to the articles of the prior art (in particular the articles comprising an uncoated polyolefin substrate). In particular, they advantageously exhibit improved surface properties and more particularly still they advantageously exhibit improved antistatic properties. Advantageously, in addition, the layer (Σ) of the article according to the invention adheres firmly to the substrate (S); this usually results in excellent persistence of the surface properties, in particular of the antistatic properties, over time, which contrasts with the poor retention of the antistatic properties of substrates coated with external antistatic agents. Finally, the Applicant has succeeded in preparing certain articles according to the invention wherein the layer (Y) was transparent. If transparence is desirable, some preferred non functionalized polyolefins (PO2) are (i) random copolymers of propylene and ethylene comprising from 2 to 6 by weight of recurring units derived from ethylene, and (ii) random copolymers of ethylene and one or more C₃-C₈ α-olefin(s) comprising from 2 to 6 wt. % of recurring units derived from the C₃-C₈ α-olefin(s); nevertheless, other non functionalized polyolefins (PO2), including homopolymers of propylene, can also be used successfully to achieve the desired transparency.

Subsequently, a subject-matter of the present invention is a process for the synthesis of a high-performance article based on a polyolefin substrate, which process exhibits numerous advantages with respect to the processes of the prior art without exhibiting the disadvantages thereof.

To this end, the invention relates to a process for the manufacture of the article as described above, comprising the following successive stages:
at least one aqueous emulsion composed of at least one polyolefin composition (C2*) comprising:
(i) at least one functionalized polyolefin (POg), obtained by grafting acid and/or anhydride groups to at least one nonfunctionalized polyolefin (PO2), the acid and/or anhydride groups optionally being neutralized in all or in part by at least one neutralizing agent,
(ii) at least one emulsifying agent, and
(iii) at least one dispersing liquid comprising water,
is applied at least once to at least a portion of the surface of a substrate (S) comprising at least one polyolefin composition (C1) comprising at least one nonfunctionalized polyolefin (PO1), so that at least a portion of the surface of the said substrate (S) is coated with a wet layer (Σ*) composed of the aqueous emulsion;
at least a portion of the water is removed from the wet layer (Y*) [i.e. (Σ), the layer obtained after the removal of at least a portion of the water];
the substrate (S) coated with the layer (Σ) is assembled with other components, if necessary, so as to obtain the article.

The application of the aqueous emulsion to at least a portion of the surface of the substrate (S) is advantageously carried out by covering the said portion with the aqueous emulsion.

The layer (Σ) is preferably essentially dry, that is to say that most of the water is removed from the wet layer (Σ*). However, it has been found that the presence of a very small amount of water in the layer (Y) can sometimes have a beneficial effect on certain properties of the article manufactured, in particular its antistatic properties.

The process according to the invention is advantageously used by a converter of polyolefin materials as replacement for a prior process according to which the converter manufactured an article comprising a substrate (S) identical to that of the article manufactured by the process according to the invention except that (i) it was devoid of the layer (Y) [either that the substrate (S) was uncoated or that it was coated with a layer with a chemical nature other than that of the layer (Σ)] and (ii) the said prior process has meanwhile been supplemented or modified by the converter for the purposes of improving the antistatic properties of the substrate (S) of the article.

Subsequently, a subject-matter of the present invention is a particularly advantageous use of a layer of plastic comprising a grafted polyolefin.

To this end, the invention relates to the use of a layer (Y) composed of at least one polyolefin composition (C2) comprising:
at least one functionalized polyolefin (POg), obtained by grafting acid and/or anhydride groups to at least one nonfunctionalized polyolefin (PO2), the acid and/or anhydride groups optionally being neutralized in all or in part by at least one neutralizing agent, and
at least one emulsifying agent, as antistatic coating for at least a portion of the surface of a substrate (S) comprising at least one polyolefin composition (C1) comprising at least one nonfunctionalized polyolefin (PO1).

Finally, a subject-matter of the present invention is another particularly advantageous use of a layer of plastic comprising a grafted polyolefin.

To this end, the invention relates to the use of a layer (Y) composed of at least one polyolefin composition (C2) comprising:
at least one functionalized polyolefin (POg), obtained by grafting acid and/or anhydride groups to at least one nonfunctionalized polyolefin (PO2), the acid and/or anhydride groups optionally being neutralized in all or in part by at least one neutralizing agent,
at least one emulsifying agent, and
elemental carbon, preferably carbon powder or carbon nanotubes and particularly preferably carbon nanotubes, as electrically conducting coating and preferably, in addition, as thermally conducting coating of at least a portion of the surface of a substrate (S) comprising at least one polyolefin composition (C1) comprising at least one nonfunctionalized polyolefin (PO1).

More particularly, the invention relates to the use of a layer (Y) composed of at least one polyolefin composition (C2) comprising:
at least one functionalized polyolefin (POg), obtained by grafting acid and/or anhydride groups to at least one nonfunctionalized polyolefin (PO2), said nonfunctionalized polyolefin (PO2) being preferably (i) a random copolymer of propylene and ethylene comprising from 2 to 6 wt. % of recurring units derived from ethylene or (ii) a random copolymer of ethylene and one or more C₃-C₈ α-olefin(s) comprising from 2 to 6 wt. % of recurring units derived from the C₃-C₈ α-(X-olefin(s), the acid and/or anhydride groups optionally being neutralized in all or in part by at least one neutralizing agent,
at least one emulsifying agent, and
carbon nanotubes,
   as transparent electrically conducting coating and preferably, in addition, as thermally conducting coating of at least a portion of the surface of a substrate (S) comprising at least one polyolefin composition (C1) comprising at least one nonfunctionalized polyolefin (PO1).

The examples which follow are intended to illustrate the invention without, however, limiting the scope thereof.

### EXAMPLE 1

### According To The Invention

The resin Priex® 25097, sold by Solvay, is a random copolymer of propylene and of ethylene grafted with maleic anhydride which is not neutralized, comprising approximately 5% of repeat units derived from ethylene, a weight-average molecular mass of approximately 55 000 and an amount of grafted anhydride groups, expressed as amount of graftable maleic anhydride grafted, of approximately 0.45% by weight (amount with respect to the weight of the grafted polyolefin).

An aqueous emulsion composed of approximately 25% by weight of the commercial resin Priex® 25097, approximately 7% by weight of an alkoxylated nonionic emulsifying agent and approximately 68% by weight of water was prepared according to a technique well proven by a person skilled in the art who is an expert in the preparation of aqueous emulsions. The aqueous emulsion thus obtained is also sold as is by Solvay under the name Priex® 702. Description of the substrate.

The substrate used according to the example is a thin sheet of polypropylene composed of approximately 65% by weight of a random copolymer of propylene and of ethylene, Moplen® RP210M, sold by Basell (supposed to comprise approximately 5% of repeat units derived from ethylene), and of approximately 35% by weight of a thermoplastic elastomer, Adflex® X100G, also from Basell (supposed to be a diblock copolymer, one block of which is a block of polypropylene homopolymer and the other block of which is a block of Ethylene-Propylene Rubber).

Use is made, in covering the propylene sheet with the aqueous emulsion Priex® 702, of:
a backing on which the substrate has been fixed using a clip,
Liquipette transfer pipettes, which have made it possible to deposit, in a controlled way, the amount of aqueous emulsion necessary to cover the whole of the polypropylene sheet,
a set of calibrated scrapers, which makes it possible to spread the deposited emulsion over the substrate while observing a precise covering thickness,
a simple air flow oven with a heated chamber, which makes it possible to cause the covered sheet to enter and then to leave automatically the heated chamber, for a time which can be adjusted using a timer.

The following procedure was used to carry out the covering: the polypropylene sheet was fixed and then a scraper was placed right at the top of the sheet. A dribble of the aqueous emulsion, rehomogenized beforehand by simple stirring, was subsequently deposited using a Liquipette transfer pipette, immediately below the scraper. A scraper (one hand at each end) was drawn, with a fairly fast, uniform and emphatic movement, from top to bottom, so as to spread the emulsion over the entire height of the polypropylene sheet. The scraper was chosen so as to deposit a wet layer of aqueous emulsion which, once dried (cf. below), had a thickness of approximately 12 μm. Care was taken to deposit the amount of emulsion just sufficient, that is to say sufficient to cover an entire face of the sheet but reducing to virtually zero the amount of excess emulsion at the bottom of the sheet once the drawing operation was complete. Immediately afterwards, the sheet thus coated was placed in the heated oven at 120° C. and was left therein for 60 seconds. The drying of the sheet was continued in the open air for approximately 1 hour.

A polypropylene sheet coated with a layer composed of approximately 78% by weight of polypropylene grafted with maleic anhydride, Priex® 25097, and approximately 22% by weight of alkoxylated nonionic emulsifying agent was thus obtained.

It was observed visually and with an optical microscope that the layer of polypropylene grafted with maleic anhydride coating the polypropylene sheet was particularly smooth and uniform.

It was confirmed manually that the adhesion of the layer of polypropylene grafted with maleic anhydride to the polypropylene sheet was excellent.

Measurements of the Antistatic Properties: Determination of the Half Charge Decay Time

A Shishido Honestmeter device was used. A sample of the substrate described above was charged electrostatically using an electrode and an acquisition system. The charges were injected at the surface of the sample by the corona effect and their gradual disappearance was monitored from the moment where the external contribution of charges had ceased. The half charge decay time was defined as being the time necessary for the initial charge to be reduced by half, for defined hygrometry and at a defined temperature. To be specific, the distance between the test specimen and the voltage source was 20 mm; a voltage of 5 kV was applied for 5 s before being cut off; the test specimens were conditioned by residing in an atmosphere with a relative humidity of 60% at approximately 20° C. for 24 hours.

A half charge decay time of 3 to 4 s, i.e. a very low half charge decay time, was measured: the sample according to Example 1 exhibited excellent antistatic properties.

### EXAMPLE 2

### According to the Invention

The procedure was carried out exactly as in Example 1, except that the alkoxylated nonionic emulsifying agent was replaced weight for weight with a cationic emulsifying agent.

It was observed that the cationic aqueous emulsion had an excellent stability over time.

Furthermore, a half charge decay time of 3 to 4 s, i.e. a very low half charge decay time, was measured: the sample according to Example 2 exhibited excellent antistatic properties.

1-35. (canceled)

36: An article comprising
at least one substrate (S) comprising at least one polyolefin composition (C1) comprising at least one nonfunctionalized polyolefin (PO1), the said substrate comprising a surface,
and at least one layer (Σ) coating at least a portion of the surface of the said substrate, the said layer (Σ) being composed of at least one polyolefin composition (C2) comprising:
at least one functionalized polyolefin (POg) obtained by grafting acid and/or anhydride groups to at least one nonfunctionalized polyolefin PO2), the acid and/or anhydride groups optionally being neutralized in all or in part by at least one neutralizing agent, and
at least one emulsifying agent.

37: The article according to claim 36, wherein the substrate (S) is a film.

38: The article according to claim 36, wherein the nonfunctionalized polyolefin (PO1) a blend composed, on the one hand, of a propylene homopolymer or of a random polymer of propylene and of ethylene comprising from 2 to 6% by weight of repeat units derived from ethylene and, on the other hand, of a diblock copolymer, one block of which is a block of a propylene homopolymer or of a random copolymer of propylene and of ethylene comprising from 2 to 6% by weight of repeat units derived from ethylene and the other block of which s a block of a copolymer of propylene and of ethylene comprising from 20 to 45% by weight of repeat units derived from ethylene.

39: The article according to claim 36, wherein the nonfunctionalized polyolefin (PO2) is a polyethylene homopolymer or a polpropylene homopolymer.

40: The article according to claim 39, wherein the acid and/or anhydride groups of the functionalized polyolefin (POg) are no neutralized.

41: The article according to claim 36, wherein the acid and/or anhydride groups of the functionalized polyolefin (POg) are not neutralized.

42: The article according to claim 41, wherein the polyolefin composition (C2) is devoid of functionalized polyolefin other than the functionalized polyolefin (POg).

43: The article according to claim 39, wherein the emulsifying agent is a cationic emulsifying agent.

44: The article according to claim 36, wherein the emulsifying agent is an alkoxylated cat onic emulsifying agent.

45: The article according to claim 36, wherein the emulsifying agent is an alkoxylating nonionic emulsifying agent selected from the group consisting of condensates of alkylene oxide with fatty acid, condensates of alkylene oxide with fatty alcohol and condensates of alkylene oxide with alkylphenol.

46: The article according to claim 36, wherein the emulsifying agent is alkoxylated and comprises at least 4 and at most 12 mol of alkylene oxide.

47: The article according to claim 36, wherein the polyolefin composition (C2) additionally comprises carbon nanotubes.

48: The article according to claim 36, wherein the polyolefin composition (C2) comprises more than 10 by weight, with respect to the total weight of the composition, of the emulsifying agent.

49: The article according to claim 36, wherein it is a finished product.

50: A process for the manufacture of the article according to claim 36, comprising the following successive stages:
at least one aqueous emulsion composed of at least one polyolefin composition (C2*) comprising:
(i) at least one functionalized polyolefin (POg), obtained by grafting acid and/or anhydride groups to at least one nonfunctionalized polyolefin (PO2) the acid and/or anhydride groups optionally being neutralized in all or in part by at least one neutralizing agent
(ii) at least one emulsifying agent, and
(iii) at least one dispersing liquid comprising water,
is applied at least once to at least a portion of the surface of a substrate (S) comprising at least one polyolefin composition (C1) comprising at least one nonfunctionalized polyolefin (PO), so that at least a portion of the surface of the said substrate (S) is coated with a wet layer composed of the aqueous emulsion;
at east a portion of the water is removed from the wet layer (Σ*) [i.e. (Σ), the layer obtained after the removal of at least a portion of the water];
the substrate (S) coated with the layer (Σ) is assembled with other components, if necessary, so as to obtain the article.

51: The process according to claim 50, wherein the application of the aqueous emulsion to at east a portion of the surface of the substrate (S) is carried out by covering the said portion with the aqueous emulsion.

52: The process according to claim 50, wherein is used by a converter of polyolefin materials as replacement for a prior process according to which the converter manufactured an article comprising a substrate (S) identical to that of the article manufactured by the process as claimed here except that (i) it was devoid of the layer (Σ) [either that the substrate (S) was uncoated or that it was coated with a layer with a chemical nature other than that of the layer (Σ)] and (ii) the said prior process has meanwhile been supplemented or modified by the converter for the purposes of improving the antistatic properties of the substrate (S) of the article.

53: An article composed essentially of
at least one substrate (S) comprising at least one polyolefin composition (C1) comprising at least one nonfunctionalized polyolefin (PO1), the said substrate comprising a surface
and at least one layer (coating at least a portion of the surface of the said substrate, the said layer (Σ) being composed of at least one polyolefin composition (C2) comprising:
at least one functionalized polyolefin (POg) obtained by grafting acid and/or anhydride groups to at least one nonfunctionalized polyolefin (PO2), the acid and/or anhydride groups optionally being neutralized in all or in part by at least one neutralizing agent, and
at least one emulsifying agent.

54: The article according to claim 53, wherein the substrate (S) is a film.

55: The article according to claim 53, w herein the substrate (S) is a fibre.

56: The article according to claim 53, wherein
the substrate (S) is composed essentially of the polyolefin composition (C1), the said polyolefin composition (C1) comprising more than 95% by weight, with respect to the total weight of the composition, of the nonfunctionalized polyolefin (PO1), and
the polyolefin composition (C2) comprises more than 50% by weigh, with respect to the total weight of the functionalized polyolefin (POg).

57: The article according to claim 53, wherein the nonfunctionalized polyolefin (PO2) is a polyethylene or a polypropylene, and the acid and/or anhydride groups of the functionalized polyolefin (POg) are not neutralized.

58: The article according to claim 53, wherein the polyolefin composition (C2) is devoid of functionalized polyolefin other than the functionalized polyolefin (POg).

59: The article according to claim 53, wherein the emulsifying agent is an alkoxylated nonionic emulsifying agent chosen from condensates of alkylene oxide with fatty acid, condensates of alkylene oxide with fatty alcohol and condensates of alkylene oxide with alkylphenol, the said emulsifying agent comprising at least 4 and at most 12 mol of alkylene oxide.

60: The article according to claim 53, wherein the polyolefin composition (C2) is devoid of nonemulsifying antistatic agent.

61: The article according to claim 53, wherein the polyolefin composition (C2) comprises more than 10% by weight, with respect to the total weight of the composition, of the emulsifying agent.

62: An article comprising
at east one substrate (S) comprising at least one polyolefin composition (C1) comprising at least one nonfunctionalized polyolefin (PO1), the said substrate comprising a
and at least one layer (Σ) coating at least a portion of the surface of the said substrate, the said layer (Σ) being composed of at least one polyolefin composition (C2) comprising:
at least one functionalized polyolefin (POg) obtained by grafting acid and/or anhydride groups to at east one non functionalized polyolefin (PO2), the acid and/or anhydride groups optionally being neutralized in all or in part by at least one neutralizing agent, and
at least one emulsifying agent.
wherein the substrate (S) is a fiber.

63: The article according to claim 62, wherein
the substrate (S) is composed essentially of the polyolefin composition (C1), the said polyolefin composition (C1) comprising more than 95% by weight, with respect to the total weight of the composition, of the nonfunctionalized polyolefin (PO1), and
the polyolefin composition (C2) comprises more than 50 by weight, with respect to the total weight of the composition, of the functionalized polyolefin (POg), and is devoid of functionalized polyolefin other than the functionalized polyolefin (POg) and of nonemulsifying antistatic agent.

64: The article according to claim 62, wherein the nonfunctionalized polyolefin PO2 is a polyethylene or a polypropylene, and the acid and or anhydride groups of the functionalized polyolefin (POg) are not neutralized.

65: The article according to claim 62, wherein the emulsifying agent is an alkoxylated nonionic emulsifying agent chosen from condensates of alkylene oxide with fatty acid, condensates of alkylene oxide with fatty alcohol aid condensates of alkylene oxide with alkylphenol, the said emulsifying agent comprising at least 4 and at most 12 mol of alkylene oxide, and the said emulsifying agent being contained in the polyolefin composition (C2) in an amount of more than 10% by weight, with respect to the total weight of the composition.
